(19) United States
(12) Patent Application Publication
(10) Pub. No.: US 2019/0266923 A1
(43) Pub. Date: Aug. 29, 2019

(54) DIGITALLY PRINTED DUAL FUNCTION HEAT TRANSFER LABEL

(71) Applicant: AVERY DENNISON RETAIL INFORMATION SERVICES, LLC, Mentor, OH (US)

(72) Inventors: Tyler DAHLSTROM, Visalia, CA (US); Michael BARTON, Mentor, OH (US); Matthew WITTERSTAETTER, Frisco, TX (US)

(21) Appl. No.: 16/286,274

(22) Filed: Feb. 26, 2019

Related U.S. Application Data
(60) Provisional application No. 62/635,205, filed on Feb. 26, 2018.

(51) Int. Cl. G09F 3/10; B41M 7/00; B41M 5/52; A41D 27/08; B65C 5/04; B65C 9/00; G09F 3/02

(52) U.S. Cl. CPC G09F 3/10; B41M 7/0054; B41M 5/5209; A41D 1/04; B65C 5/04; B65C 9/0015; G09F 3/02; A41D 27/08

(57) ABSTRACT

A digitally printed heat transfer label and method of manufacture is disclosed. The heat transfer label and method of manufacture provides a more efficient process with less waste. The method comprises providing multiple digitally printed images, each with distinct purposes and each provided in a different area on a substrate to produce a substrate which may be used to replace multiple heat transfer sheets.

### CROSS REFERENCE TO RELATED APPLICATION(S)

The present application claims priority to and the benefit of United States provisional utility patent application No. 62/635,205 filed Feb. 26, 2018, which is incorporated herein by reference in its entirety.

### FIELD OF THE INVENTION

The field of the invention relates generally to digitally printed heat transfer labels and methods for manufacturing the same.

### BACKGROUND

The present invention relates generally to a digitally printed heat transfer label providing for multiple functions. The present subject matter is especially suitable for labeling fabrics, textiles, and other similar materials. In accordance with embodiments of the present subject matter, digitally printed heat transfer labels for apparel items such as clothing and other articles are provided. Particular relevance is found in connection with the method of making the digitally printed heat transfer labels that streamlines the prior art complex process and achieves improved aesthetics and less waste. Accordingly, the present specification makes specific reference thereto. However, it is to be appreciated that aspects of the present inventive subject matter are also equally amenable to other like applications.

Printed labels are well-known and commonly used to transfer a graphic, such as text or a figure, onto an item, such as apparel or merchandise. A label is usually pre-printed with a graphic, and then the graphic is transferred from the label to the item using a heated pad or iron or the like. Printing techniques such as gravure printing, offset printing, flexographic printing, screen printing and digital printing all can be used to create a heat transfer label. Typically, the graphic is formed on a web or substrate onto which a release layer is applied. The ink graphic is applied to the release layer, followed by an adhesive. Thus, the adhesive is applied to the top surface of the graphic. When a user then applies the graphic to the item, the label is turned adhesive-side down onto the item and heat is applied to the back of the label substrate to transfer the graphic to the item from the release layer of the label substrate.

This composition of ink and adhesive is not efficient, as each layer of the graphic must be mixed and applied separately. The ink and the adhesive cannot be mixed together and applied in one stroke as the ink and the adhesive need to maintain different chemical characteristics. For example, labels on garments, where a garment may be an article of clothing, must be stretchable, water wash resistant, and chemical dry-cleaning resistant. For these reasons, the ink used in the graphic must be cross-linked to form a 3-dimensional network. Whereas, the adhesive cannot be cross-linked. The adhesive must be capable of being thermally activated and heat sealable in order for the user to transfer the graphic from the label to the garment. Thus, the ink and adhesive cannot be combined in one mixing pot as the mixture may result in the adhesive losing its thermoplastic characteristics. Further, the resulting graphic and adhesive layer can result in a halo around the graphic portion of the label, which can be aesthetically undesirable.

The present invention discloses a digitally printed heat transfer label and method of manufacture that provides a more efficient process with less waste, as well as prevents halos. The method would replace the multistep process, using a sheet or roll-fed process. Specifically, the method comprises multiple digitally printed images on a substrate to produce multi-function heat transfer labels for the apparel industry.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a digitally printed heat transfer label and method of manufacture. The method comprises applying a release coating to a carrier or substrate, printing the image, applying a polymeric coating over the image, applying adhesive powders, drying the liquid, and cooling the resulting images.

In one embodiment, a first image is printed by a digital printer onto a heat transfer substrate first portion. A second image having a different function than the first image is printed on a second portion of the heat transfer sheet. Then a garment is provided and the heat transfer sheet is placed in operative position with the garment. Heat and/or pressure is applied such that the first and second images are placed on the garment in first and second positions distinct from one another.

In a further embodiment, a heat transfer sheet is provided having a first and second portion, with each of the first and second portions having different heat transfer images digitally printed thereon. The image printed in the first portion may be a graphic or other illustration and the image printed in the second portion may be a regulatory, brand information, or other compliance related label. The first image first portion is provided on the front or outer portion of the garment and the second image on the second portion is provided on an interior portion of the garment such as in the back neck panel area.

In one embodiment, a digitally printed heat transfer label for use on an apparel item includes a first printed image and a second printed image, each applied to a substrate, where the first printed image is configured to be applied to a first portion of the substrate and the second printed image is configured to be applied to a second portion of the substrate distinct from the first portion. The digitally printed heat transfer label also includes a polymeric coating and an adhesive layer. In some embodiments, the digitally printed heat transfer label further includes a release layer.

In some embodiments, the adhesive layer is a powder adhesive. The adhesive layer may be configured to be applied to at least one of a first printed image and a second printed image of a digitally printed heat transfer label while the at least one of the first printed image and the second printed image is still wet. In some embodiments, the powder adhesive is configured to be melted via an infrared (IR) lamp.

According to some embodiments, the first printed image of a digitally printed heat transfer label is a graphic or other fanciful depiction and the second printed image of a digitally printed heat transfer label is a compliance, regulatory or brand identifier.

The preset disclosure also contemplates methods for manufacturing a digitally printed heat transfer label. In some embodiments, the method includes creating a heat transfer design to form a first image, printing the first image on a first portion of a substrate, printing a second image having one of compliance, regulatory or branding information on a second portion of the substrate distinct from the first image printed on the first portion of the substrate, applying a polymeric coating over at least one of the first image or the second image, providing a garment, bonding the first image and the second image to the garment, and cooling the garment with the first image and second image bonded thereon. In some embodiments, the garment is an article of clothing.

According to some embodiments, the first image and second image are bonded to the garment with heat and pressure, while in other embodiments, the first image and the second image are bonded to the garment via digital or laser machinery.

In some embodiments, a method for manufacturing a digitally printed heat transfer label further includes applying at least one adhesive powder to at least one of the first image or the second image. In still further embodiments, the method may comprise providing a residual release layer.

According to other aspects of the present invention, an apparel item having at least one digitally printed heat transfer label includes a base material, a heat transfer label applied to the base material, an apparel item having a front side and a backside, a first printed image of the heat transfer label applied to a first area of the apparel item and a second printed image of the heat transfer label applied to a second area of the apparel item distinct from the first area, a polymeric coating applied over at least one of the first printed image or the second printed image, and an adhesive layer applied over the polymeric coating.

In some embodiments, the base material of an apparel item is a non-woven fabric material. Further still, the base material may be incorporated into the apparel item. According to some embodiments, the residual release layer defines an outermost layer of the heat transfer label.

The polymeric coating, the first printed image, and the second printed image in some embodiments are flexible and extensible. For example, the polymeric coating, the first printed image, and the second printed image can be configured to stretch at least about 3% in at least one direction without substantially cracking. In addition, at least one of the polymeric coating, the first printed image, and the second printed image can be formed from a curable composition or system. According to some embodiments, the first printed image and the second printed image are printed with one or more ultraviolet-curable inks.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

These, as well as other objects and advantages of this invention, will be more completely understood and appreciated by referring to the following more detailed description of the presently preferred embodiments of the invention in conjunction with the accompanying drawings, of which:

FIG. 1 illustrates a digitally printed heat transfer sheet having two labels disposed on two different portions of the sheet;

FIG. 2 illustrates a flowchart of manufacturing the digitally printed heat transfer label in accordance with the present invention; and

FIG. 3 illustrates a garment which has been provided with the digitally printed heat transfer labels.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A heat transfer label, such as a digitally printed heat transfer label, and method of manufacture is disclosed. The heat transfer label and method of manufacture provides a more efficient process with less waste, as well as prevents halos. The disclosed method replaces the multistep process, which required the use of two or more heat transfer sheets, separate printing of sheets, and separate bonding of sheets to the garment.

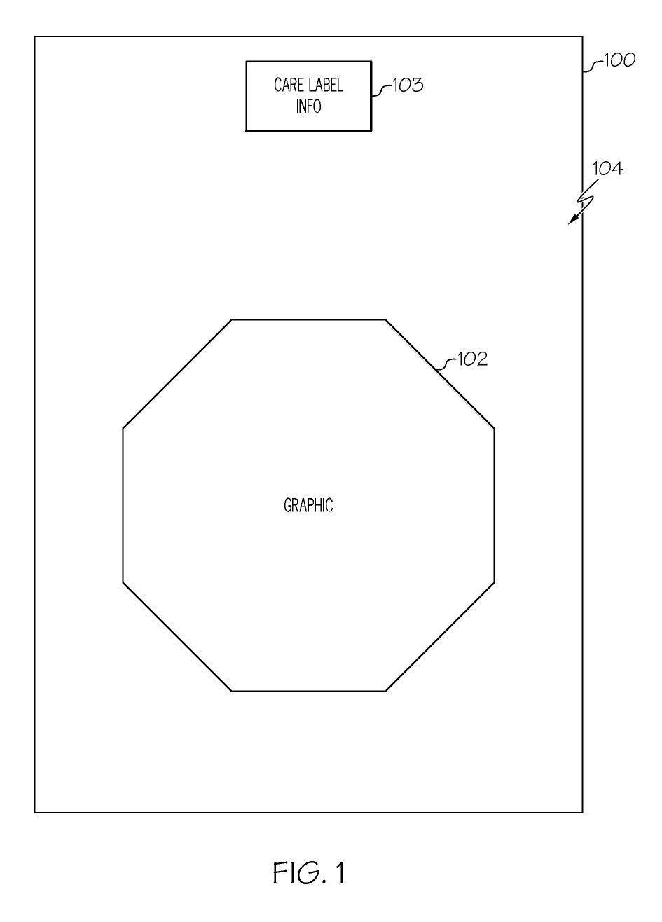

Referring initially to the drawings, FIG. 1 illustrates a heat transfer sheet 100, such as a digitally printed heat transfer sheet. The heat transfer sheet 100 generally comprises a first printed image 102 and a second printed image 103, either one of which can be a digitally printed image, and each of which can be configured to define one or more graphics and/or text. First printed image 102 can include a graphic or other fanciful depiction and second printed image 103 can provide regulatory, branding, compliance, or other information that may be required for consumer use of the garment, to which the first and second printed images 102, 103 will be applied, or identification of the manufacturer. In one exemplary embodiment, the heat transfer sheet 100 may comprise at least a first printed image 102 and a second printed image 103 in order to provide multiple graphics and/or text to be applied by a user. The first printed image 102 and second printed image 103 may vary in size and/or shape. The shape of either the first printed image 102, second printed image 103, or any additional printed images may be one of any geometrical shape.

The heat transfer sheet 100 generally comprises a substrate 104 on which the first printed image 102 and the second printed 103 are supported. The substrate 104 can be any suitable substance known to a person of ordinary skill in the art. For example, the substrate 104 can be a paper-based material, such as a paper web or paper sheet. In some embodiments, substrate 104 is made at least in part of recycled paper. Further, substrate 104 may be recyclable. Substrate 104 can be any other suitable material as one of ordinary skill in the art would understand.

As stated supra, the first printed image 102 and second printed image 103 are applied to a base material. The base material is typically a non-woven fabric material, but can be any suitable material as is known in the art. The base material may also be a combination of various materials known in the art to obtain different physical properties. The base material is typically produced using routine methods known in the art. Further, the base material would typically be part of, or incorporated into, an apparel item 106. The apparel item 106 may be a garment or an article of clothing, such as a t-shirt, jersey, sweatshirt, etc., or any other suitable article of clothing as is known in the art. The heat transfer sheet 100 can be applied to the front side or the back side of the apparel item 106, or even on a tag of the apparel item 106, depending on the wants and/or needs of the manufacturer or user. In an embodiment where there are multiple heat transfer labels to be applied, the at least one heat transfer label may be placed on a tag of the apparel item as well as directly on the apparel item. For example, a first printed image 102 may be placed directly on the front of an apparel item 106, and a second printed image 103 may be placed on a tag of the apparel item 106. In some embodiments, for example when an apparel item 106 does not include a tag, a second printed image 103 may be placed directly on an inner surface of the back side of apparel item 106.

When the first printed image 102 and second printed image 103 are joined to an apparel item 106, the adhesive coating or layer (not shown) generally contacts (i.e., is directly adjacent to) a surface of the apparel item 106. For example, the adhesive coating layer may contact an exterior surface or an interior surface of the apparel item 106, depending upon where a printed image is to be placed. Printed images, such as heat transfer labels, may be provided with a polymeric coating or layer (and/or any residual release layer material) which defines an outermost layer for the first printed image 102 or the second printed image 103 on the apparel item 106 that serves to protect the first and second printed images 102 and 103 from damage.

The polymeric coating and/or one or both of the first printed image 102 and the second printed image 103 may comprise any suitable material that is capable of achieving the desired degree of flexibility and extensibility for a particular decorating (i.e., labeling) application. More particularly, at least a portion of the polymeric coating and/or first printed image 102 and second printed image 103 ideally stretches (i.e., extends or elongates) at least about 5%, more specifically, from about 3% to about 12%, in at least one direction without substantially cracking, speckling, distorting, or forming any other substantial defect in the first printed image 102 and second printed image 103 when the printed images are applied to the apparel item 106.

If desired, the polymeric coating and/or printed images 102 and 103 may be formed from a curable composition or system, for example, an energy curable composition or system, such as printing the image with ultraviolet-curable inks to provide a first printed image 102 and a second printed image 103 that include optically readable information, have excellent durability against wind, rain, and light, and can be produced more simply and at low cost. Other suitable inks can be used for printing the first and second printed images 102 and 103 as is known in the art, as long as the inks provide visually recognizable information and durability against adverse conditions. Furthermore, the images are typically printed with a digital printer, or offset presses, such as Indigo® available from HP of Palo Alto, Calif. Images can also be produced using conventional flexographic or gravure printing equipment.

Then, the heat transfer sheet 100 is placed on a surface 108 of apparel item 106, for example, a shirt fabric, such that the adhesive layer faces the surface 108. To transfer the first and second printed images 102 and 103, heat and pressure are applied over the surface 108 with a label applicator. When heat and pressure are applied, the adhesive layer softens and adheres to the surface 108 permanently. The heat transfer sheet 100 is peeled off, and since the adhesion strength between the first and second printed images 102 and 103 and the adhesive layer is greater than that between the first and second printed images 102 and backing 104 of the heat transfer sheet 100, the first and second printed images 102 and 103 remain attached to the surface 108.

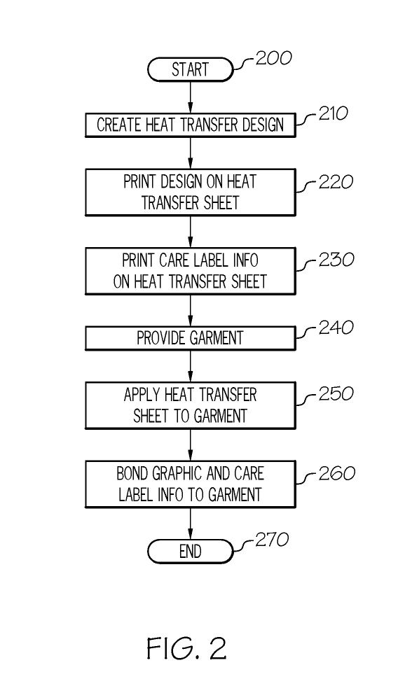

As illustrated in FIG. 2, a method of manufacturing a heat transfer sheet, such as a digitally printed heat transfer label, is shown. At 200 the process is started and then at step 210 a design is created such as either by using a database of available designs or creating artwork through any commercially available software package. At 220 a first image, such as a design, is printed onto the heat transfer sheet and at 230 a second image, such as a care label, is printed onto a backing of the heat transfer sheet via a digital printer or other suitable printer. It is within the scope of the invention to print any additional number of images onto the backing of the heat transfer sheet, as a person of ordinary skill in the art will understand. Moreover, the printing may occur at a single step or multiple steps, as provided here. A polymeric coating is applied over the printed images and the adhesive powders are dried or melted (or at least partially melted) using infrared (IR) lamps or air impingement dryers or oven, or any other suitable drying apparatus. The resulting images are cooled to set the labels, which completes preparation of the heat transfer sheet. Transfer sheets and/or paper backing can be included to aid in the movement of the heat transfer label from the manufacturing point to the assembly or application area.

A heat transfer application stage occurs beginning at step 240 when a garment, such as an apparel item, is provided. The digitally printed heat transfer sheet is applied to the garment, such as an apparel item, at step 250. Garment typically falls in the category of soft goods, such as products made from fabric, textiles, or other pliable or bendable materials. Examples include apparel items, such as clothing of any type, such as shirts, jerseys, and sweatshirts, as well as other products such as banners, flags, covers, bedding, blankets, throws and other soft goods. A heat transfer sheet can be provided as a cut single or on a roll-to-roll format. Application equipment at this stage or phase can include heat transfer press machines at step 250 to bond the images to the garment at step 260, for example an Avery Dennison CTB-5 Heat Transfer Bonder. Digital or laser transfer approaches and equipment may be suitable for some products. Then the garment is removed and the process ends at step 270.

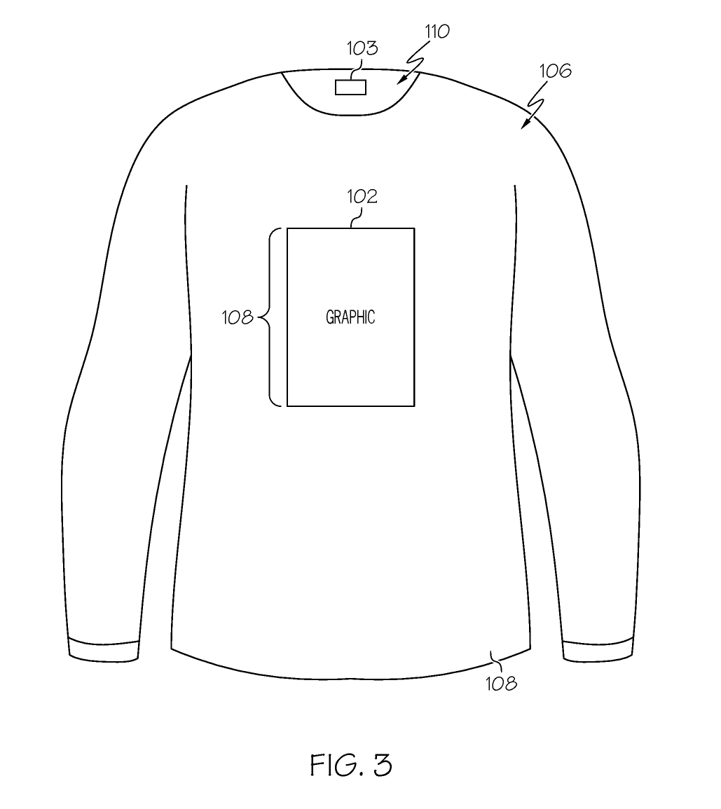

Referring to FIG. 3, the apparel item 106 is shown with the first printed image 102 applied in a first area and the second printed image 103 applied in a second area. The second area may be the back neck portion 110. In some embodiments, the back neck portion 110 may include a tag onto which second printed image 103 is applied directly. The first portion, onto which first printed image 102 may be applied, may be the outer portion of the garment. For example, the first portion may be an exterior surface of a front face (or back face) of apparel item 106. It is within the scope of the present invention to apply first printed image 102, second printed image 103, and any additional number of printed images to any portion of the apparel item 106, as may be desired by the manufacturer.

Thus, the present invention discloses a heat transfer sheet, such as a digitally printed heat transfer label, and method of manufacture that provides a more efficient process with less waste, as well as prevents halos. The disclosed method replaces the multistep process of the prior art, using a sheet or roll-fed process. Specifically, the method comprises adding adhesive powder to a digital image printed on a substrate to produce a high stretch, multi-color, photographic-quality label for the apparel industry.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A digitally printed heat transfer label, comprising:
a first printed image and a second printed image, each applied to a substrate, where the first printed image is configured to be applied to a first portion of the substrate and the second printed image is configured to be applied to a second portion of the substrate distinct from the first portion;
a polymeric coating; and
an adhesive layer.

2. The digitally printed heat transfer label of claim 1, further comprising a release layer.

3. The digitally printed heat transfer label of claim 1, where the adhesive layer is a powder adhesive.

4. The digitally printed heat transfer label of claim 3, where the powder adhesive is configured to be applied to at least one of the first printed image and the second printed image while the at least one of the first printed image and the second printed image is still wet.

5. The digitally printed heat transfer label of claim 4, where the powder adhesive is configured to be melted via an infrared (IR) lamp.

6. The digitally printed heat transfer label of claim 1, where the first printed image is a graphic or other fanciful depiction and the second printed image is a compliance, regulatory or brand identifier.

7. A method for manufacturing a digitally printed heat transfer label, comprising:
creating a heat transfer design to form a first image;
printing the first image on a first portion of a substrate;
printing a second image having one of compliance, regulatory or branding information on a second portion of the substrate distinct from the first image printed on the first portion of the substrate;
applying a polymeric coating over at least one of the first image or the second image;
providing a garment;
bonding the first image and the second image to the garment; and
cooling the garment with the first image and second image bonded thereon.

8. The method of claim 7, where the garment is an article of clothing.

9. The method of claim 7, where bonding is done with heat and pressure.

10. The method of claim 7, where bonding is done via digital or laser machinery.

11. The method of claim 7, further comprising the step of applying at least one adhesive powder to at least one of the first image or the second image.

12. The method of claim 7, further comprising the step of providing a residual release layer.

13. An apparel item having at least one digitally printed heat transfer label, comprising;
a base material;
a heat transfer label applied to the base material;
an apparel item having a front side and a backside;
a first printed image of the heat transfer label applied to a first area of the apparel item and a second printed image of the heat transfer label applied to a second area of the apparel item distinct from the first area;
a polymeric coating applied over at least one of the first printed image and the second printed image; and
an adhesive layer applied over the polymeric coating.

14. The apparel item of claim 13, where the base material is a non-woven fabric material.

15. The apparel item of claim 13, where the base material is incorporated into the apparel item.

16. The apparel item of claim 13, where a residual release layer defines an outermost layer of the heat transfer label.

17. The apparel item of claim 13, where the polymeric coating, the first printed image, and the second printed image are flexible and extensible.

18. The apparel item of claim 13, where the polymeric coating, the first printed image, and the second printed image are configured to stretch at least about 3% in at least one direction without cracking.

19. The apparel item of claim 13, where at least one of the polymeric coating, the first printed image, and the second printed image is formed from a curable composition or system.

20. The apparel item of claim 19, where the first printed image and the second printed image are printed with one or more ultraviolet-curable inks.
